(19) United States
(12) Patent Application Publication
(10) Pub. No.: US 2020/0273202 A1
(43) Pub. Date: Aug. 27, 2020

(54) IMAGE PROCESSING APPARATUS AND IMAGE PROCESSING METHOD

(71) Applicant: TOYOTA JIDOSHA KABUSHIKI KAISHA, Toyota-shi (JP)

(72) Inventors: Kazuya NISHIMURA, Okazaki-shi (JP); Naoki UENOYAMA, Nisshin-shi (JP); Yoshihiro OE, Kawasaki-shi (JP); Hirofumi KAMIMARU, Fukuoka-shi (JP)

(73) Assignee: TOYOTA JIDOSHA KABUSHIKI KAISHA, Toyota-shi (JP)

(21) Appl. No.: 16/736,887

(22) Filed: Jan. 8, 2020

(30) Foreign Application Priority Data
Feb. 27, 2019 (JP) 2019-034503

(51) Int. Cl. G06T 7/73; G06T 5/00; G06T 5/50

(52) U.S. Cl. CPC G06T 7/73; G06T 5/004; G06T 2207/30196; G06T 2207/20081; G06T 2207/30252; G06T 5/50

(57) ABSTRACT

An image processing apparatus includes: a calculation unit that calculates a size of a target object on an occasion when the target object exists along a peripheral edge part of a captured image captured by an external image capturing apparatus, based on a plurality of images containing the target object that needs to undergo image processing for protecting privacy; a determination unit that determines a region, on an image, that is captured in a state where a part of the target object protrudes from a peripheral edge part of the captured image, based on the size of the target object calculated by the calculation unit; and an image processing unit that performs the image processing on the region on the image determined by the determination unit.

### INCORPORATION BY REFERENCE

The disclosure of Japanese Patent Application No. 2019-034503 filed on Feb. 27, 2019 including the specification, drawings and abstract is incorporated herein by reference in its entirety.

### BACKGROUND

### 1. Technical Field

The present disclosure relates to an image processing apparatus and an image processing method.

### 2. Description of Related Art

Japanese Patent Application Publication No. 2017-103748 discloses an image processing apparatus which performs image processing for privacy protection. Based on a vanishing point that is at an identical position on a plurality of chronologically successive images, and a positon and a size of a designated target object, the image processing apparatus estimates a region where the target object exists, and performs pixelation processing on a region at an identical position to that of the existing region.

### SUMMARY

While a user designates the target object for the pixelation processing in accordance with JP 2017-103748 A, such a target object for pixelation processing can also be learned through machine learning such that the image processing apparatus can recognize the target object. In this case, if the learning is supposed to be performed only with images that the target object is entirely in, there can be a possibility that the target object that protrudes from a peripheral edge part of a range of image capturing cannot be recognized. It can be considered in order to restrain this that images that a part of the target object is in are additionally learned. To learn images that a part of a target object is in however exceedingly increases objects to be learned, which causes costs and time and labor to increase.

Therefore, an object of the present disclosure is to provide an image processing apparatus and an image processing method capable of enhancing processing efficiency of image processing for protecting privacy.

An image processing apparatus according to an aspect of the present disclosure includes: a calculation unit that calculates the size of a target object on the occasion when the target object exists along a peripheral edge part of a captured image captured by an external image capturing apparatus, based on a plurality of images containing the target object that needs to undergo image processing for protecting privacy; a determination unit that determines a region, on an image, that is captured in the state where a part of the target object protrudes from a peripheral edge part of the captured image, based on the size of the target object calculated by the calculation unit; and an image processing unit that performs the image processing on the region on the image determined by the determination unit.

In the aspect above, a learning model unit that generates a learning model through learning using tutor data containing an image of the target object and outputs a determination result of whether or not an object contained in an input image is the target object may be further included, and the image processing unit may further perform the image processing on the object when the determination result output by the learning model unit indicates that the object contained in the input image is the target object.

In the aspect above, a recording unit that records an image having undergone the image processing by the image processing unit may be further included.

In the aspect above, the image processing may be any of pixelation processing, blurring processing, and processing of fitting a fixed image.

In the aspect above, the target object may be a license plate of a vehicle or a person.

In the aspect above, the image capturing apparatus may be a drive recorder.

An image processing method according to another aspect of the present disclosure is an image processing method that is performed by a processor and includes: a calculation step of calculating the size of a target object on the occasion when the target object exists along a peripheral edge part of a captured image captured by an external image capturing apparatus, based on a plurality of images containing the target object that needs to undergo image processing for protecting privacy; a determination step of determining a region, on an image, that is captured in the state where a part of the target object protrudes from a peripheral edge part of the captured image, based on the size of the target object calculated in the calculation step; and an image processing step of performing the image processing on the region on the image determined in the determination step.

There can be provided according to the present disclosure an image processing apparatus and an image processing method capable of enhancing processing efficiency of image processing for protecting privacy.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram exemplarily showing a configuration of an image processing apparatus system including a management server which is an image processing apparatus;

FIG. 2 is a diagram exemplarily showing an image captured by a drive recorder;

FIG. 3 is a diagram exemplarily showing an image captured by the drive recorder;

FIG. 4 is a diagram exemplarily showing an image captured by the drive recorder;

and

FIG. 5 is a flowchart for exemplarily explaining operation of the management server shown in FIG. 1.

### DETAILED DESCRIPTION OF EMBODIMENTS

Preferred embodiments of the present disclosure are described with reference to the appended drawings. Notably, elements with the same signs in the figures have the same or similar configurations.

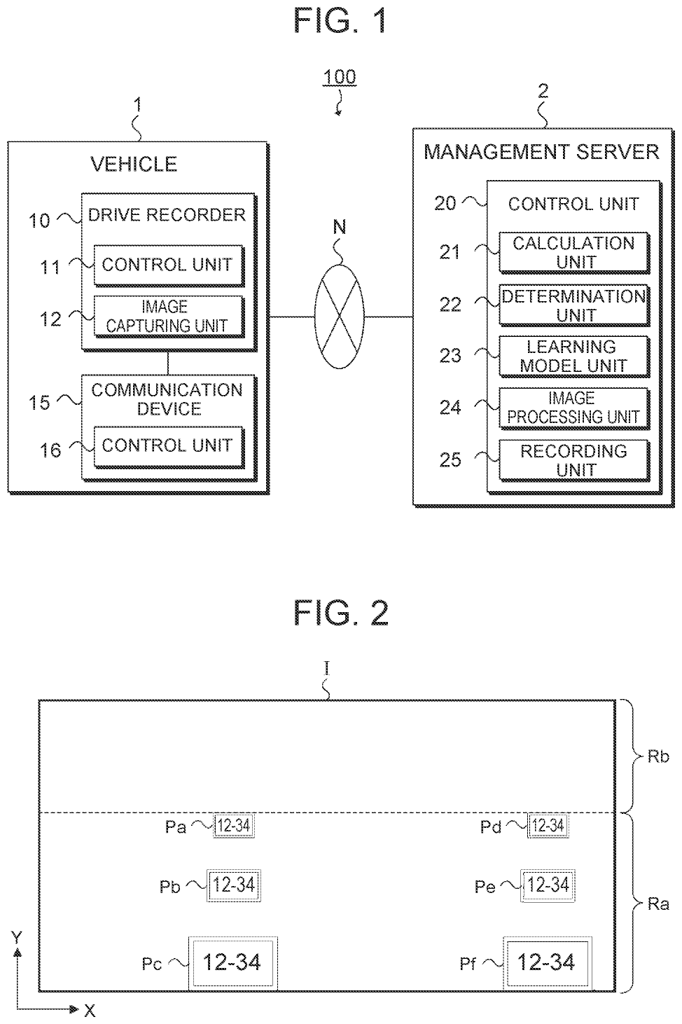

Referring to FIG. 1, a configuration of an image processing apparatus system 100 including a management server 2 which is an image processing apparatus according to an embodiment is described. The image processing apparatus system 100 exemplarily includes a drive recorder (image capturing apparatus) 10 and a communication device 15 which are mounted on a vehicle 1, and the management server 2 which acquires and manages images captured by the drive recorder 10. The drive recorder 10 and the communication device 15 are configured to be communicable with each other via a bus.

The communication device 15 and the management server 2 are configured to be communicable with each other via a network N, for example, including a wireless network.

With the image processing apparatus system 100 in the present embodiment, first, a picture captured by the drive recorder 10 is transmitted to the management server 2 via the communication device 15. Subsequently, the management server 2 performs image processing for protecting privacy on a target object privacy of which needs to be protected based on the received picture, and performs image processing for protecting privacy also on a region, on an image, which is captured in a state where a part of a target object protrudes from a peripheral edge part of the image. Subsequently, the management server 2 records an image after the image processing in a storage apparatus. Details of the image processing apparatus system 100 as above are hereafter described.

The vehicle 1 in the present embodiment exemplarily includes a control apparatus including a central processing unit (CPU) and a memory, and the like as well as the drive recorder 10 and the communication device 15.

The drive recorder 10 shown in FIG. 1 exemplarily has, as a functional configuration, a control unit 11 and an image capturing unit 12. The drive recorder 10 exemplarily includes, as a physical configuration, a control apparatus including a CPU and a memory, a camera, a storage apparatus, an operation unit, a display, a loudspeaker, a communication device and the like. The CPU executes a predetermined program stored in the memory and the storage apparatus, and thereby, functions of the control unit 11 and the image capturing unit 12 are realized.

The communication device 15 exemplarily has, as a functional configuration, a control unit 16. The communication device 15 exemplarily includes, as a physical configuration, a control apparatus including a CPU and a memory, a storage apparatus, an operation unit, a display, a loudspeaker, a communication device and the like. The CPU executes a predetermined program stored in the memory and the storage apparatus, and thereby, functions of the control unit 16 are realized.

The management server 2 exemplarily has, as a functional configuration, a control unit 20. The management server 2 exemplarily includes, as a physical configuration, a control apparatus including a CPU and a memory, a storage apparatus, a communication device and the like. The CPU executes a predetermined program stored in the memory and the storage apparatus, and thereby, functions of the control unit 20 are realized.

Functions of the control unit 20 of the management server 2 are hereafter described in detail. The control unit 20 exemplarily includes a calculation unit 21, a determination unit 22, a learning model unit 23, an image processing unit 24 and a recording unit 25.

The calculation unit 21 calculates a size, on an image, of a target object which needs to undergo image processing for protecting privacy, based on a plurality of images captured by the drive recorder 10. The image processing for protecting privacy exemplarily corresponds to pixelation processing, blurring processing, processing of fitting a fixed image, or the like. Examples of the target object include a license plate of a vehicle, a person, and the like. In the present embodiment, a case where the target object is a license plate of a vehicle is exemplarily described.

A size, on an image, of the license plate may be a size of the license plate on an occasion when the license plate exists along a peripheral edge part of a captured image, and can be exemplarily calculated as follows. The calculation unit 21 calculates the size of the license plate displayed at each predetermined position on the image for each of such predetermined positions, based on the plurality of images captured by the drive recorder 10.

Referring to FIG. 2, license plates displayed on an image are described. This figure exemplarily shows an image I captured by the drive recorder 10. When in front of the own vehicle, other vehicles exist, the image I captured by the drive recorder 10 can be segmented into a region Ra in which license plates of the other vehicles are displayed (for example, any of license plates Pa to Pf), and a region Rb in which the license plates of the other vehicles are not displayed (region above the ground surface).

As shown in FIG. 2, the license plates Pa to Pf of the other vehicles existing ahead tend to move downward in the image I and their sizes on the image tend to increase, as their distances from the vehicle shorten. This tendency also applies to persons existing in front of the vehicle. Accordingly, by identifying their positions on the image, the sizes of the license plates and the persons displayed at the identified positions can be identified.

Here, the size of each of the license plates and the persons tends to depend on the position in the height (Y-axis) direction on the image and not to depend on the position in the width (X-axis) direction on the image. Accordingly, the position, on the image, identified when the calculation unit 21 calculates the size may be identified by designating a Y-coordinate on the image.

The determination unit 22 shown in FIG. 1 determines a region, on the image, which is captured in the state where a part of the license plate protrudes from a peripheral edge part of the image, based on the size of the license plate calculated by the calculation unit 21.

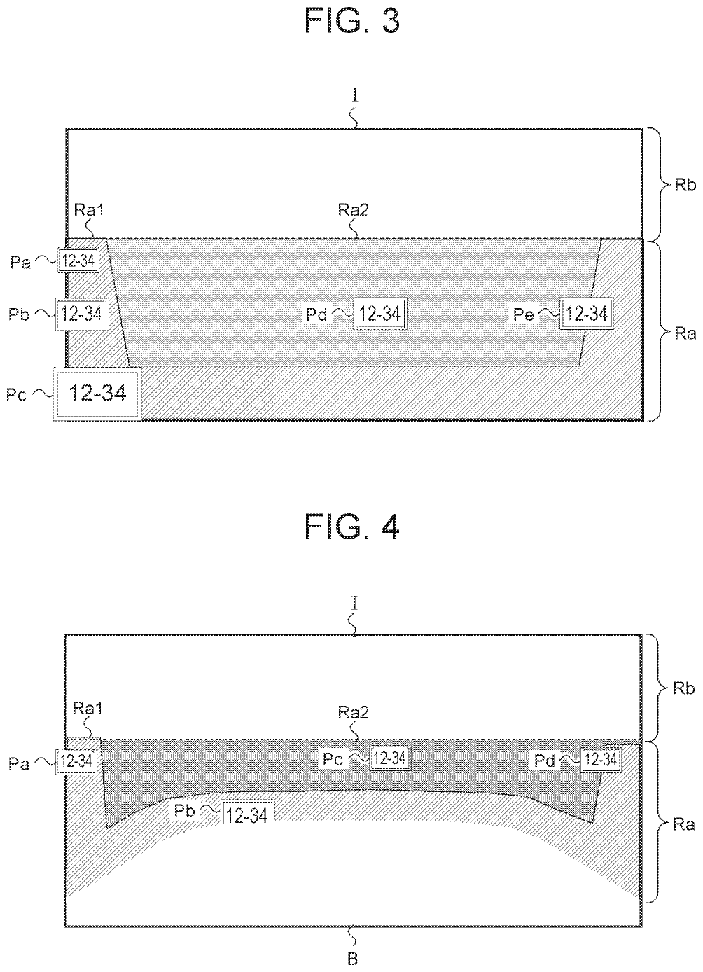

Referring to FIG. 3, the region, on the image, which is captured in the state where a part of the license plate protrudes from the peripheral edge part of the image I is described. This figure exemplarily shows the image I captured by the drive recorder 10. The region Ra and the region Rb therein are similar to the region Ra and the region Rb in FIG. 2.

A region Ra1 shown in FIG. 3 is the region in which an image of the license plate is captured in the state where a part of the license plate protrudes from the peripheral edge part of the image I, that is, the region determined by the determination unit 22.

For example, the license plate Pa, Pb, Pc an image of which is captured in the state where a part thereof protrudes from the image I is to be displayed within the region Ra1 in a state where the license plate partially lacks. Meanwhile, as to the license plate Pd, Pe an image of which is captured in a state where it does not protrude from the image I, the license plate Pd is to be displayed in a state where the entire part thereof is contained within a region Ra2 except the region Ra1, or the license plate Pe is to be displayed in a state where the entire part thereof is contained within the region Ra1 and the region Ra2.

Referring to FIG. 4, a variation of the region determined by the determination unit 22 is described. This figure exemplarily shows the image I captured by the drive recorder 10. Its difference from FIG. 3 is in that an image of a hood portion B of the vehicle is captured in a lower portion of the image I captured by the drive recorder 10. The region Ra and the region Rb therein are similar to the regions Ra and the regions Rb in FIG. 2 and FIG. 3.

The region Ra1 shown in FIG. 4 is the region determined by the determination unit 22. In this case, the region Ra1 is a region in which an image of a license plate is captured in the state where a part of the license plate protrudes from the peripheral edge part of the image I or an upper edge of the hood portion B.

For example, the license plate Pa, Pb an image of which is captured in the state where a part thereof protrudes from the image I or the upper edge of the hood portion B is to be displayed within the region Ra1 in the state where the license plate partially lacks. Meanwhile, as to the license plate Pc, Pd an image of which is captured in the state where it does not protrude from the image I or the upper edge of the hood portion B, the license plate Pc is to be displayed in the state where the entire part thereof is contained within the region Ra2 except the region Ral, or the license plate Pd is to be displayed in the state where the entire part thereof is contained within the region Ra1 and the region Ra2.

The learning model unit 23 shown in FIG. 1 generates a learning model through learning using tutor data including images of license plates of vehicles. The learning model unit 23 causes the learning model to output a determination result of whether or not an object contained in an image input into the learning model is a license plate of a vehicle.

The image processing unit 24 performs the image processing on the region Ral, on the image, determined by the determination unit 22. When the determination result output from the learning model unit 23 indicates that the object contained in the input image is a license plate of a vehicle, the image processing unit 24 performs the image processing on the object contained in the input image.

The recording unit 25 causes the storage apparatus to record the image having undergone the image processing by the image processing unit 24.

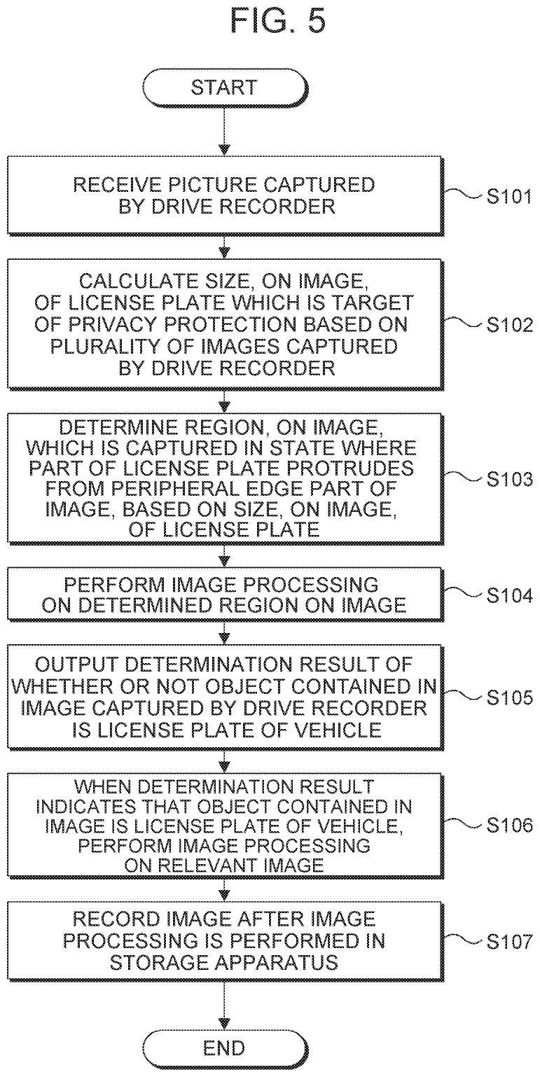

Referring to FIG. 5, operation of the management server 2 in the embodiment is exemplarily described. First, the management server 2 receives a picture captured by the drive recorder 10 (step S101).

Subsequently, the calculation unit 21 of the management server 2 calculates the size, on an image, of the license plate which is a target of privacy protection based on a plurality of images captured by the drive recorder 10 (step S102).

Subsequently, the determination unit 22 of the management server 2 determines the region, on the image, which is captured in the state where a part of the license plate protrudes from the peripheral edge part of the image, based on the size, on the image, of the license plate, the size being calculated in step S102 above (step S103).

Subsequently, the image processing unit 24 of the management server 2 performs the image processing on the region, on the image, determined in step S103 above (step S104).

Subsequently, the learning model unit 23 of the management server 2 outputs the determination result of whether or not the object contained in the image captured by the drive recorder 10 is a license plate of a vehicle (step S105).

Subsequently, when the determination result output in step S105 above indicates that the object contained in the image captured by the drive recorder 10 is a license plate of a vehicle, the image processing unit 24 of the management server 2 performs the image processing on the object contained in the image captured by the drive recorder 10 (step S106).

Subsequently, the recording unit 25 of the management server 2 causes the storage apparatus to record the image after the image processing is performed in step S104 above and in step S106 above (step S107). Then, the operation is ended.

As mentioned above, according to the management server 2 in the embodiment, the size of a license plate on an occasion when the license plate exists along a peripheral edge part of an image captured by the drive recorder 10 can be calculated based on a plurality of images containing the license plate which is a target of privacy protection, and based on the calculated size, a region, on the image, which is captured in a state where a part of the license plate protrudes from the peripheral edge part of the captured image can be determined to perform image processing on the determined region on the image.

Thereby, since the image processing can be performed evenly on the region, on the image, in which an image of a part of the license plate is possibly captured, processing of determining whether or not such an image of a part of the license plate is captured can be omitted. In addition, processing of learning of images each of which a license plate is partially in can also be omitted.

Therefore, according to the management server 2 in the embodiment, processing efficiency of image processing for protecting privacy can be enhanced.

### MODIFICATIONS

Notably, the present disclosure is not limited to the embodiment mentioned above but can be implemented in various forms without departing from the scope and spirit of the present disclosure. Accordingly, the embodiment above is merely exemplary in all means and should not be construed as limiting. For example, the processing steps mentioned above can be performed in any order or in parallel as long as this does not cause any contradiction in the processing.

While for the embodiment mentioned above, a case where image processing is performed on an image captured by the drive recorder 10 has been described, modes in which the present disclosure is applicable are not limited to this case. For example, the present disclosure can also be applied to a case where image processing is performed on an image captured by a monitoring camera (image capturing apparatus).

Moreover, components of the drive recorder 10, the communication device 15 and the management server 2 are not limited to the components in the embodiment mentioned above but any addition or the like of components can be properly made as needed. Moreover, functions which the management server 2 has do not have to be realized exclusively by one server apparatus but may be distributed to and realized by a plurality of server apparatuses. For example, the calculation unit 21, the determination unit 22 and the image processing unit 24, and the learning model unit 23 and the recording unit 25 out of the functions of the management server 2 shown in FIG. 1 may be distributed to different server apparatuses. Furthermore, some or all of the functions which the management server 2 has may be implemented in the vehicle 1.

What is claimed is:

1. An image processing apparatus comprising:
a calculation unit that calculates a size of a target object on an occasion when the target object exists along a peripheral edge part of a captured image captured by an external image capturing apparatus, based on a plurality of images containing the target object that needs to undergo image processing for protecting privacy;
a determination unit that determines a region, on an image, that is captured in a state where a part of the target object protrudes from a peripheral edge part of the captured image, based on the size of the target object calculated by the calculation unit; and
an image processing unit that performs the image processing on the region on the image determined by the determination unit.

2. The image processing apparatus according to claim 1, further comprising
a learning model unit that generates a learning model through learning using tutor data containing an image of the target object and outputs a determination result of whether or not an object contained in an input image is the target object, wherein
the image processing unit further performs the image processing on the object when the determination result output by the learning model unit indicates that the object contained in the input image is the target object.

3. The image processing apparatus according to claim 1, further comprising a recording unit that records an image having undergone the image processing by the image processing unit.

4. The image processing apparatus according to claim 1, wherein the image processing is any of pixelation processing, blurring processing, and processing of fitting a fixed image.

5. The image processing apparatus according to claim 1, wherein the target object is a license plate of a vehicle or a person.

6. The image processing apparatus according to claim 1, wherein the image capturing apparatus is a drive recorder.

7. An image processing method that is performed by a processor, the image processing method comprising:
a calculation step of calculating a size of a target object on an occasion when the target object exists along a peripheral edge part of a captured image captured by an external image capturing apparatus, based on a plurality of images containing the target object that needs to undergo image processing for protecting privacy;
a determination step of determining a region, on an image, that is captured in a state where a part of the target object protrudes from a peripheral edge part of the captured image, based on the size of the target object calculated in the calculation step; and
an image processing step of performing the image processing on the region on the image determined in the determination step.
